(19) United States
(12) Patent Application Publication
(10) Pub. No.: US 2025/0102099 A1
(43) Pub. Date: Mar. 27, 2025

(54) LONG POT LIFE CURABLE EPOXY SYSTEM FOR CURED-IN-PLACE PIPE REHABILITATION PROCESS

(71) Applicant: BLUE CUBE IP LLC, St. Louis, MO (US)

(72) Inventor: Huifeng Qian, Pearland, TX (US)

(21) Appl. No.: 18/768,486

(22) Filed: Jul. 10, 2024

Related U.S. Application Data
(60) Provisional application No. 63/514,654, filed on Jul. 20, 2023.

(51) Int. Cl. F16L 55/165; C08G 59/24; C08G 59/50; C08J 5/24

(52) U.S. Cl. CPC F16L 55/1656; C08G 59/245; C08G 59/5026; C08G 59/5073; C08J 5/246; C08J 5/249; F16L 55/1654; C08J 2363/02

(57) ABSTRACT

Provided herein is a curable epoxy resin composition for use in a cured-in-place pipe application. The curable epoxy resin composition comprises an epoxy resin component comprising at least one epoxy resin and an accelerator component comprising an imidazole. Also provided is a curable pipe liner comprising a flexible pipe lining material impregnated with a curable epoxy composition as provided herein. Also provided is a method of repairing or rehabilitating a pipe comprising inserting a curable pipe liner into an existing pipe in need of repair or rehabilitation, inflating the liner until the liner is pressed against an inner wall of the pipe, and curing the liner until the liner hardens.

### CROSS-REFERENCE TO RELATED APPLICATIONS

This application claims priority to U.S. Provisional Application No. 63/514,564, filed on Jul. 20, 2023, which is hereby incorporated by reference in its entirety.

### FIELD

The present disclosure is directed to cured-in-place pipe (CIPP) lining systems, to compositions useful in such systems, and to methods for repairing or rehabilitating pipe that utilize such systems.

### BACKGROUND

Cured-in-place pipe (CIPP) is a trenchless technology for non-intrusive installation, replacement, or rehabilitation of underground piping systems such as sewer, industrial, potable water, and other similar piping applications. One of the main advantages of CIPP is its ability to rehabilitate pipes without the need for extensive excavation, which reduces disruption to the surrounding environment and minimizes the cost and time associated with traditional pipe replacement methods. Therefore, CIPP is often considered a cost-effective and efficient solution for rehabilitating underground pipelines.

The CIPP process can include inserting a flexible liner impregnated with a thermosetting resin into an existing pipe that is being repaired or rehabilitated. The thermosetting resin can be activated by heat or ultraviolet light. The thermosetting resin can be provided in the form of an epoxy resin. However, many commonly used epoxy resins have a relatively short pot life of less than 24 hours, which is challenging for wet-out-of-liner off-site applications. The pot life is the measure of the working time during which the felt liner in a cured-in-place application can be impregnated with a thermoset resin system, transported to a job site, and cured properly in the host pipe before the viscosity of the curable composition increases and the composition is no longer capable of performing the desired working procedure. Therefore, a short pot life can make transporting the epoxy resin to the job site and completing the repair or rehabilitation within the necessary time frame difficult. Further, it can be desirable to have an epoxy resin that has a fast reactivity once the curing process starts. However, conventional epoxy resins may not have both a long pot life and a fast reactivity.

Accordingly, there is a need in the art for a thermosetting resin that offers a long pot life and a fast reactivity, and systems and methods for using the thermosetting resin in a CIPP application.

### SUMMARY

Provided herein is a curable epoxy composition comprising an epoxy resin component comprising at least one epoxy resin, and an accelerator component comprising an imidazole.

Also provided herein is a curable pipe liner comprising a flexible pipe lining material impregnated with a curable epoxy composition. The curable epoxy composition may comprise one or more of (1) an epoxy resin component comprising one or more epoxy resins, and (2) an accelerator component comprising an imidazole, and (3) one or more optional components, each of which may be selected as generally described herein.

Also provided herein is a CIPP lining system comprising (1) a curable epoxy composition, (2) a pipe lining material as carrier material and reinforcement. The curable epoxy composition may comprise one or more of (1) an epoxy resin component comprising one or more epoxy resins, and (2) an accelerator component comprising an imidazole, and (3) one or more optional components, each of which may be selected as generally described herein

Also provided herein is a method for repairing or rehabilitating a pipe, comprising inserting a curable pipe liner into an existing pipe in need of repair or rehabilitation; inflating the liner until the liner is pressed against an inner wall of the pipe; and curing the liner until the liner hardens. The curable epoxy composition may comprise one or more of (1) an epoxy resin component comprising one or more epoxy resins, and (2) an accelerator component comprising an imidazole, and (3) one or more optional components, each of which may be selected as generally described herein.

These and other aspects of the present disclosure are described in further detail below.

### DESCRIPTION OF THE FIGURES

FIG. 1 is a graph depicting the change in measured viscosity over time for a curable epoxy composition prepared as described in Inventive Example 1.

### DETAILED DESCRIPTION

Provided herein is a curable epoxy composition that exhibits a long pot life, fast reactivity, and is particularly useful in CIPP applications. Also provided is a curable pipe liner comprising a flexible pipe lining material impregnated with a curable epoxy composition as provided herein. Also provided is a method of repairing or rehabilitating a pipe comprising inserting a curable pipe liner into an existing pipe in need of repair or rehabilitation, inflating the liner until the liner is pressed against an inner wall of the pipe, and curing the liner until the liner hardens.

These compositions, systems, and methods are described in further detail below.

### Curable Epoxy Composition

The curable composition may comprise one or more of (1) an epoxy resin component comprising one or more epoxy resins, and (2) an accelerator component comprising an imidazole, and (3) one or more optional components.

The curable composition may comprise the epoxy resin component and the accelerator component in a ratio of at least about 5:1, at least about 10:1, at least about 15:1, or at least about 20:1 on a weight basis. Typically, the curable composition may comprise the epoxy resin component and the accelerator component in a ratio of no greater than about 100:1, no greater than about 90:1, no greater than about 80:1, or no greater than about 75:1 on a weight basis. For example, the curable composition may comprise the epoxy resin component and the accelerator component in a ratio of from about 10:1 to about 100:1 on a weight basis.

The curable composition may comprise the epoxy resin component and the accelerator component in a ratio of at least about 5:1, at least about 10:1, at least about 20:1, at least about 30:1; at least about 40:1; or at least about 50:1 on a molar basis. Typically, the curable composition may comprise the epoxy resin component and the accelerator component in a ratio of no greater than about 200:1, no greater than about 180:1, no greater than about 160:1, no greater than about 140:1; no greater than about 120:1; or no greater than about 100:1 on a molar basis. For example, the curable composition may comprise the epoxy resin component and the accelerator component in a ratio of from about 5:1 to about 200:1 on a molar basis.

The curable composition preferably has a pot life at 10° C. of at least about 24 hours, and more preferably at least about 48 hours. For example, the curable composition may have a pot life at 10° C. of at least about 3 days, at least about 4 days, at least about 5 days, at least about 6 days, or at least about 8 days.

The curable composition preferably has a gel time at 25° C. of at least about 6 hours, and more preferably at least about 12 hours. For example, the curable composition may have a gel time at 25° C. of at least about 18 hours, at least about 24 hours, or at least about 2 days.

The curable composition preferably has a curing time at 80° C. of no greater than about 8 hours. For example, the curable composition may have a curing time at 80° C. of no greater than about 7 hours, no greater than about 6 hours, no greater than about 5 hours, no greater than about 4 hours, no greater than about 3 hours, no greater than about 2 hours, or no greater than about 1 hour.

### Definitions

As used herein, the term “alkyl” encompasses both straight and branched chain alkyl groups comprising from one to about 20 carbon atoms, unless otherwise indicated Non-limiting examples of alkyl groups include methyl, ethyl, propyl, butyl, pentyl, and hexyl. The alkyl group may be a straight-chain alkyl group or a branched alkyl group (e.g., isopropyl). In some embodiments, the alkyl group is optionally independently substituted with one or more substituents selected from the group consisting of methoxyl, carboxyl, and a halogen.

As used herein, the term “aryl” refers to an aromatic moiety comprising from 6 to 14 carbon atoms, unless otherwise indicated. The aryl group may be optionally independently substituted with one or more substituents selected from the group consisting of methyl, ethyl, methoxyl, and carboxyl. Non-limiting examples of aryl groups include phenyl, naphthyl, benzyl, tolyl, and xylyl.

As used herein, the term “alkoxyl” refers to a group of the form —OR′, wherein R′ is alkyl as defined herein. For example, the group —OCH₃ may be referred to herein as “methoxyl.” The group —OCH₂CH₃ may be referred to herein as “ethoxyl.”

As used herein, the term “hydroxyalkyl” refers to a group of the form —R′OH, wherein R′ is alkyl as defined herein. For example, the group —CH₂OH may be referred to herein as “hydroxymethyl.” The group —CH₂CH₂OH may be referred to herein as “hydroxyethyl.”

As used herein, the term “cyanoalkyl” refers to a group of the form —R′OH, wherein R′ is alkyl as defined herein. For example, the group —CH₂C≡N may be referred to herein as “cyanomethyl.” The group —CH₂CH₂C≡N may be referred to herein as “cyanoethyl.”

As used herein, the term “aminoalkyl” refers to a group of the form —R′NH₂, wherein R′ is alkyl as defined herein. For example, the group —CH₂NH₂ may be referred to herein as “aminomethyl.” The group —CH₂CH₂NH₂ may be referred to herein as “aminoethyl.”

As used herein, the term “hydrogen” includes both stable isotopes of hydrogen, namely ¹H (also known as protium) and ²H (also known as deuterium).

### Epoxy Resin Component

The epoxy resin component may comprise any well-known epoxy resin. As used herein, the term “epoxy resin” means a composition which possesses one or more vicinal epoxy groups per molecule, i.e. at least one 1,2-epoxy group per molecule. In general, the epoxy resin compound may be a saturated or unsaturated aliphatic, cycloaliphatic, aromatic or heterocyclic compound which possesses at least one 1,2-epoxy group. Such compound can be substituted, if desired, with one or more non-interfering substituents, such as halogen atoms, hydroxy groups, ether radicals, lower alkyls and the like.

The epoxy resins useful in the present invention may include monoepoxides, diepoxides, polyepoxides or mixtures thereof. Illustrative compounds useful in the practice of the instant invention are described in the Handbook of Epoxy Resins by H. E. Lee and K. Neville published in 1967 by McGraw-Hill, New York; and U.S. Pat. No. 4,066,628, both of which are incorporated herein by reference.

The compound having at least one vicinal epoxy group may comprise a compound having two vicinal epoxy groups. For example, particularly useful compounds which can be used in the practice of the present invention are epoxy resins having the following formula:

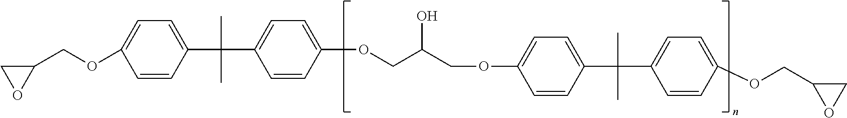

wherein n has an average value of generally 0 or more, preferably from 0 to about 100, and more preferably from about 0.1 to about 50.

The epoxy resins useful in the present invention may include, for example, epoxy resins used herein may include reaction products of epichlorohydrin with polyfunctional alcohols, phenols, bisphenols, halogenated bisphenols, hydrogenated bisphenols, novolac resins, o-cresol novolacs, phenol novolacs, polyglycols, polyalkylene glycols, cycloaliphatics, carboxylic acids, aromatic amines, aminophenols, or combinations thereof. The preparation of epoxy compounds is described for example in Kirk-Othmer, Encyclopedia of Chemical Technology, 3rd Ed., Vol. 9, pp. 267-289. Non-limiting examples of known epoxy resins that include, for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, alkyl C₁₂-C₁₄ mono alkylglycidyl ether, 1,4-butanediol diglycidylether, 1,6-hexanediol diglycidyl ether, 2-ethylhexylglycidyl ether, neopentyl diglycidyl ether, trimethylpropane triglycidyl ether and glycidyl ether of carboxylic acids; and any combination thereof.

Examples of diepoxides particularly useful in the present invention include diglycidyl ether of bisphenol A, diglycidyl ether of bisphenol F, and diglycidyl ether of 2,2-bis(3,5-dibromo-4-hydroxyphenyl) propane (generally referred to as tetrabromobisphenol A), Mixtures of any two or more diepoxides can also be used in the practice of the present invention.

Other diepoxides which can be employed in the practice of the present invention include the diglycidyl ethers of dihydric phenols, such as those described in U.S. Pat. Nos. 5,246,751; 5,115,075; 5,089,588; 4,480,082 and 4,438,254, all of which are incorporated herein by reference; or the diglycidyl esters of dicarboxylic acids such as those described in U.S. Pat. No. 5,171,820, incorporated herein by reference. Other suitable diepoxides include for example, aw-diglycidyloxyisopropylidene-bisphenol-based epoxy resins such as those commercially known as D.E.R.™ 300, D.E.N.™ 400, D.E.R.™ 500, D.E.R.™ 600, D.E.R.™ 700, D.E.R.™ 900 series epoxy resins, which are available products from Olin Corporation.

The epoxy resins which can be employed in the practice of the present invention also include epoxy resins prepared either by reaction of diglycidyl ethers of dihydric phenols with dihydric phenols or by reaction of dihydric phenols with epichlorohydrin (also known as “taffy resins”).

Preferred epoxy resins useful in the present invention include, for example, the diglycidyl ethers of bisphenol A; 4,4′-sulfonyldiphenol; 4,4-oxydiphenol; 4,4′-dihydroxybenzophenone; resorcinol; hydroquinone; 9,9′-bis(4-hydroxyphenyl) fluorene; 4,4′-dihydroxybiphenyl or 4,4′-dihydroxy-α-methylstilbene and the diglycidyl esters of the dicarboxylic acids mentioned previously.

Other useful epoxide compounds which can be used in the practice of the present invention are cycloaliphatic epoxides. A cycloaliphatic epoxide consists of a saturated carbon ring having an epoxy oxygen bonded to two vicinal atoms in the carbon ring for example as illustrated by the following general formula:

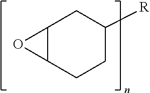

wherein R is a hydrocarbon group optionally comprising one or more heteroatoms (such as, without limitation thereto Cl, Br, and S), or an atom or group of atoms forming a stable bond with carbon (such as, without limitation thereto, Si, P and B) and wherein n is greater than or equal to 1.

The cycloaliphatic epoxide may be a monoepoxide, a diepoxide, a polyepoxide, or a mixture of those. For example, any of the cycloaliphatic epoxide described in U.S. Pat. No. 3,686,359, incorporated herein by reference, may be used in the present invention. As an illustration, the cycloaliphatic epoxides that may be used in the present invention include, for example, (3,4-epoxycyclohexyl-methyl)-3,4-epoxy-cyclohexane carboxylate, bis-(3,4-epoxycyclohexyl) adipate, vinylcyclohexene monoxide and mixtures thereof.

The epoxy resin is preferably a liquid epoxy resin. In some embodiments, the epoxy resin may be a semi-solid.

In preferred embodiments, the epoxy resin component comprises at least one diglycidyl ether.

For example, the epoxy resin component may comprise a diglycidyl ether of a compound selected from the group consisting of bisphenol A, bisphenol F, resorcinol, catechol, hydroquinone, bisphenol AP (1,1-bis(4-hydroxylphenyl)-1-phenyl ethane), bisphenol S, tetrabromobisphenol A, Phenol-formaldehyde novolac resin, alkyl substituted phenol-formaldehyde resin, alkyl C₁₂-C₁₄ mono alkylglycidyl ether, 1,4-butanediol diglycidylether, 1,6-hexanediol diglycidyl ether, 2-ethylhexylglycidyl ether, neopentyl diglycidyl ether, trimethylpropane triglycidyl ether and glycidyl ether of carboxylic acids, and combinations thereof.

The epoxy resin component may comprise the diglycidyl ether of bisphenol A, which is sold by Olin Corporation under the trademark D.E.R.™ 383, D.E.R. 331, D.E.R. 330, D.E.R. 332. For example, the epoxy resin component may consist of a diglycidyl ether of bisphenol A.

As a non-limiting example, the epoxy equivalent weight (EEW) of the epoxy resin may range from about 100 g/eq (gram equivalent weight) to about 300 g/eq. For example, the EWW of the epoxy resin may optionally rage from about 130 g/eq to about 250 g/eq, from about 150 g/eq to about 225 g/eq, or from about 170 g/eq to about 220 g/eq.

As a non-limiting example, the viscosity of the curable epoxy composition may range from about 100 to about 10,000 mPa (millipascals) at 25° C. For example, the viscosity of the curable epoxy composition may range from about 200 to about 5,000 mPa at 25° C., or from about 400 to about 2,000 mPa at 25° C.

### Accelerator Component

The accelerator component comprises one or more accelerators that promote homopolymerization of epoxy resin composition under the desired reaction conditions (for example, upon the application of heat).

For example, the accelerator component may comprise one or more imidazoles. Without being bound to a particular theory, it has been discovered that imidazoles act as anionic ring open polymerization accelerators, and may be used to provide a curable epoxy composition having the long pot life and short curing time that is highly desirable for use in CIPP applications.

For example, the accelerator component may comprise an imidazole of Formula I,

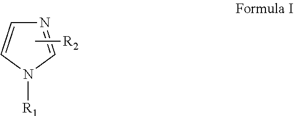

wherein R¹ and R² are each independently selected from the group consisting of hydrogen, C₁-C₂₀ alkyl, C₁-C₂₀ alkoxyl, C₁-C₂₀ hydroxyalkyl, C₁-C₂₀ cyanoalkyl, C₁-C₂₀ aminoalkyl, and monocyclic aryl.

For example, R¹ and R² may each be independently selected from the group consisting of hydrogen, C₁-C₆ alkyl, C₁-C₆ alkoxyl, C₁-C₆ hydroxyalkyl, C₁-C₆ Cyanoalkyl, C₁-C₆ aminoalkyl, and monocyclic aryl.

Non-limiting examples of R¹ and R² groups include hydrogen, methyl, ethyl, propyl, isopropyl, butyl, isobutyl, pentyl, hexyl, hydroxymethyl, hydroxyethyl, hydroxypropyl, cyanomethyl, cyanoethyl, cyanopropyl, aminomethyl, aminoethyl, aminopropyl, phenyl, and benzyl.

Non-limiting examples of imidazoles that may be present in the curable epoxy composition include 1,2-dimethylimidazole, 1-benzyl-2-methylimidazole, 1-cyanoethyl-2-ethyl-4-methylimidazole, 1-cyanoethyl-2-methylimidazole, 1-aminoethyl-2-methylimidazole, 2-methylimidazole, 4-methylimidazole, 2,4-dimethylimidazole, 2-ethylimidazole, 2-undecylimidazole, 2-heptadecylimidazole, 2-phenylimidazole, 2-ethyl-4-methyl imidazole, 2-phenyl-4-methylimdazole, and combinations thereof. For example, the curable epoxy composition may comprise an imidazole selected from the group consisting of 2-ethyl-4-methyl imidazole, 1-benzyl-2-methylimidazole, 1-cyanoethyl-2-ethyl-4-methylimidazole, and 1-(2-hydroxypropyl) imidazole.

Optionally, the accelerator component may further comprise a reactive or non-reactive accelerator diluent. Preferably, the accelerator diluent comprises a species that can liquify solid imidazole at 25° C. For example, the accelerator component may comprise a diluent selected from the group consisting of a polyol, a polyether amine, a cycloaliphatic amine, an aliphatic amine, and combinations thereof. For example, the accelerator component may comprise polyetheramine.

The curable epoxy composition may comprise the accelerator diluent in an amount of from about 0.1 weight percent to about 90 weight percent, relative to the weight of the imidazole accelerator.

The curable composition can have any suitable intrinsic viscosity prior to curing. In some embodiments, the curable composition has an intrinsic viscosity of from about 50 cps to about 5000 cps (e.g. from about 50 cps to 2000 cps, from about 100 cps to about 1000 cps, from about 200 cps to 900 cps) when stored at a temperature of 25° C. In preferred embodiments, the curable composition has an intrinsic viscosity of from about 150 cps to about 1000 cps when stored at a temperature of 25° C.

The curable composition can be cured at any suitable temperature. For example, the curable composition can be cured at a temperature of about 60° C. to about 100° C., (e.g. about 60° C., about 65° C., about 70° C., about 75° C., about 80° C., about 85° C., about 90° C., about 95° C., and about 100° C. The curable composition can be cured with hot water or steam.

The benefit of this invention is the extended working time of curable composition from impregnation to felt liner to installation. The gel time at 25° C. refers to length of working time of the curable composition at 25° C. Pot life at 10° C. refers to the length of working time of the curable composition at 10° C. Typically, the curable composition has a gel time at 25° C. of about 12 hours to 200 hours. In some embodiments, the composition has a gel time about 24 hours to 100 hours. Typically, the curable composition has a pot life at 10° C. of about 5 days to about 14 days. In some embodiments, the composition has a pot life at 10° C. of about 6 to about 10 days.

### Optional Components

The curable epoxy composition may further comprise one or more optional components.

Optional components that may be useful in the curable epoxy composition may include, but are not limited to: stabilizers; surfactants such as silicones; flow modifiers; dyes; matting agents; degassing agents; flame retardants (e.g., inorganic flame retardants, halogenated flame retardants, and non-halogenated flame retardants such as phosphorus-containing materials); toughening agents such as elastomers and liquid block copolymers; curing initiators; curing inhibitors; wetting agents; colorants; thermoplastics; processing aids; fluorescent compounds; UV stabilizers; inert fillers such as clay, talc, silica, and calcium carbonate; fibrous reinforcements; fibers such as fiberglass and carbon fiber; antioxidants; impact modifiers including thermoplastic particles; solvents such as ethers and alcohols; and mixtures thereof.

Additional non-limiting examples of optional components include a polyol, a thixotropy, a toughening agent, a surfactant, a filler, an air release agent, a pigment, and combinations thereof.

For example, the curable epoxy composition may comprise a diluent. In one embodiment, the diluent includes at least one reactive group per molecule. In one embodiment, the diluent is selected from the group consisting of D.E.R.™ 721, D.E.R. 731, D.E.R. 732, D.E.R. 736, cresyl glycidyl ether, diglycidylether of aniline, alkyl C12-C14 mono alkylglycidyl ether, 1,4-butanediodiglycidylether, 1,6-hexanediol diglycidyl ether, 2-ethylhexylglycidyl ether, neopentyldiglycidyl ether, trimethylpropanetriglycidyl ether, glycidyl ether of carboxylic acid, and combinations thereof. In one embodiment, the diluent is present within the epoxy resin in an amount of about 0.1% weight percent to about 30% weight percent based on the weight of the epoxy resin.

For example, the curable epoxy composition may comprise a toughening agent selected from the group consisting of carboxyl-terminated butadiene acrylonitrile liquid rubber (CTBN rubber), amphiphilic block copolymers, core-shell rubber, and combinations thereof.

For example, the curable epoxy composition may comprise a filler selected from the group consisting of silica, fumed silica, clay, talc, calcium carbonate, wollastonite, and combinations thereof.

Typically, the one or more optional components are present in the curable epoxy composition in an amount of about 0.1 weight percent to about 20 weight percent based on the weight of the epoxy resin.

### Cured-In-Place-Piping Applications

Also provided herein is a curable pipe liner, and a related method for repairing or rehabilitating a pipe using a CIPP system.

In a first step, a curable pipe liner is prepared by impregnating a flexible lining material with a curable epoxy composition as provided herein. Suitable materials that may be used as flexible liners for CIPP applications are generally known in the art and include, for example, natural or synthetic textile felt with an optional membrane. For example, the flexible liner may be selected from the group consisting of polyester such as poly(ethylene terephthalate), polyacrylonitrile, polyethylene, poly(ethylene naphthate), poly(p-phenylene terephthalamide), fiberglass, carbon fiber, and combinations thereof as carrier material and reinforcement. The optional membrane material can be selected from the group of consisting of a polyolefin (such as polypropylene) or thermoplastic polyurethane.

In a second step, the curable pipe liner is inserted into an existing pipe in need of repair or rehabilitation. Suitable methods for inserting a pipe liner into a pipe are generally known to those skilled in the art. For example, the liner may be inserted into the pipe using an inversion installation method, a pull-in installation method, or any other suitable method known in the art. The liner may be inserted into any pipe in need of repair or rehabilitation, for example a sewer pipe, a potable water pipe, a high pressure pipe, or an industrial pipe.

In a third step, the curable pipe liner is inflated and pressed against the inner walls of the existing pipe (for example, using water or air pressure), such that an outer surface of the pipe liner contacts an inner wall of the pipe. The curable pipe liner can thereby conform to the shape of the host pipe, and cover any defects present in the inner wall of the pipe.

In a fourth step, the curable pipe liner can be cured, or hardened, by the application of heat. Heat may be applied, for example, by supplying steam or hot water to the interior of the pipe.

The heat can be applied at a temperature of at least about 60° C.; at least about 65° C.; or at least about 70° C. Typically, the heat can be applied at a temperature no greater than about 100° C.; no greater than about 95° C.; no greater than about 90° C.; no greater than about 85° C.; or no greater than about 80° C. For example, the heat can be applied at a temperature between about 60° C. to about 100° C., and more preferably at a temperature between about 60° C. to about 80° C.

The curable pipe liner can be cured for a time period of at least about 0.5 hours; at least about 1 hours; at least about 2 hours; at least about 3 hours; or at least about 4 hours. Typically, the curable pipe liner can be cured for no longer than about 12 hours; no longer than about 10 hours; no longer than about 8 hours; or no longer than about 6 hours. For example, the curable pipe liner can be cured for a time period of about 0.5 hours to about 12 hours, more preferably for a time period between about 0.5 hours to about 5 hours.

When hardened, the curable pipe liner can become rigid and durable, creating a new structural layer within the existing pipe and providing a smooth inner surface, and restoring the structural integrity of the existing pipe.

Therefore, CIPP can effectively repair or rehabilitate various types of pipe defects, such as cracks, leaks, corrosion, and missing sections of pipe.

### EXAMPLES

The following non-limiting examples are provided to further illustrate the present disclosure.

Details regarding the components and reagents used in the following examples are provided in Table 1 below.

TABLE 1

| Material | Description | Function | Supplier |
|---|---|---|---|
| D.E.R. ™ 331 | Diglycidyl ether of | Epoxy | Olin |
| | bisphenol A | Resin | |
| D.E.R. ™ 383 | Diglycidyl ether of | Epoxy | Olin |
| | bisphenol A | Resin | |
| D.E.R. ™ 731 | Butanediol diglycidyl ether | Epoxy | Olin |
| | | Resin | |
| D.E.R. ™ 721 | Alkyl(C₁₂₋₁₄)glycidyl ether | Epoxy | Olin |
| | | Resin | |
| DMI | 1,2-dimethyl imidazole | Accelerator | Sigma- |
| | | | Aldrich |
| BETAC | BenzylTriethylAmmonium | Accelerator | Alfa |
| | Chloride | | |
| TEA | Triethanolamine | Accelerator | Dow |
| IL 169 | Tributyl(ethyl)phosphonium | Accelerator | Solvay |
| | diethylphosphate | | |
| AEP | Aminoethylpiperazine | Accelerator | Olin |
| Jeffamine | Polyetheramine | Accelerator | Huntsman |
| D230 | | diluent | |
| VESTAMIN ® | Cycloaliphatic diamine | Accelerator | Evonik |
| IPD | | diluent | |

### Inventive Example 1

A first inventive curable epoxy composition, including an epoxy resin composed of 80% D.E.R.™ 383 and 20% D.E.R.™ 721, and accelerator composed of 80% 1,2-dimethyl imidazole (DMI) and 20% Jeffamine D230 was prepared according to methods known to one skilled in the art. The mixing ratio of the epoxy resin to the accelerator was 100:4 on a weight basis.

### Inventive Example 2

A second inventive curable epoxy composition including an epoxy resin composed of 86% D.E.R.™ 383 and 14% D.E.R.™ 731, and an accelerator composed of 70% 1,2-dimethylimidazole (DMI) and 30% Jeffamine D230 was prepared according to methods known to one skilled in the art. The mixing ratio of the epoxy resin to the accelerator was 100:4 on a weight basis.

### Inventive Example 3

A third inventive curable epoxy composition including an epoxy resin composed of 80% D.E.R.™ 383 and 20% D.E.R.™ 721, and accelerator composed of 70% 1,2-dimethyl imidazole (DMI) and 30% Vestamin® IPD was prepared according to methods known to one skilled in the art. The mixing ratio of the epoxy resin to the accelerator was 100:4 on a weight basis.

### Comparative Example 1

A first comparable curable epoxy composition, including an epoxy resin composed of 100% D.E.R.™ 383, and an accelerator composed of 100% Jeffamine D230 was prepared according to methods known to one skilled in the art. The mixing ratio of the epoxy resin to the accelerator was 100:33 on a weight basis.

### Comparative Example 2

A second comparable curable epoxy composition, including an epoxy resin composed of 83% D.E.R.™ 331 and 17% D.E.R.™ 721, and an accelerator composed of 100% Triethanolamine (TEA) was prepared according to methods known to one skilled in the art. The mixing ratio of the epoxy resin to the accelerator was 100:4 on a weight basis.

### Comparative Example 3

A third comparable curable epoxy composition, including an epoxy resin composed of 83% D.E.R.™ 331 and 17% D.E.R.™ 721, and an accelerator composed of 100% AEP was prepared according to methods known to one skilled in the art. The mixing ratio of the epoxy resin to the accelerator was 100:4 on a weight basis.

### Comparative Example 4

A fourth comparable curable epoxy composition, including an epoxy resin composed of 83% D.E.R.™ 331 and 17% D.E.R.™ 721, and an accelerator composed of 100% IL 169 was prepared according to methods known to one skilled in the art. The mixing ratio of the epoxy resin to the accelerator was 100:4 on a weight basis.

The composition of each of the inventive and comparative examples are summarized in Table 2 below.

TABLE 2

| | Inventive | Inventive | Inventive | Comparative | Comparative | Comparative | Comparative |
|---|---|---|---|---|---|---|---|
| | Example | Example | Example | Example | Example | Example | Example |
| | 1 | 2 | 3 | 1 | 2 | 3 | 4 |
| Epoxy Resin | | | | | | | |
| D.E.R. ™ 331 | | | | | 83 | 83 | 83 |
| D.E.R. ™ 383 | 80 | 86 | 80 | 100 | | | |
| D.E.R. ™ 721 | 20 | | 20 | | 17 | 17 | 17 |
| D.E.R. ™ 731 | | 14 | | | | | |
| Accelerator | | | | | | | |
| and/or | | | | | | | |
| Accelerator | | | | | | | |
| diluent | | | | | | | |
| 1,2-dimethyl | 80 | 70 | 70 | | | | |
| imidazole | | | | | | | |
| (DMI) | | | | | | | |
| Jeffamine D230 | 20 | 30 | | 100 | | | |
| Vestamin IPD | | | 30 | | | | |
| Triethanolamine | | | | | 100 | | |
| (TEA) | | | | | | | |
| Aminoethylpiperazine | | | | | | 100 | |
| (AEP) | | | | | | | |
| Tributyl (ethyl) | | | | | | | 100 |
| phosphonium | | | | | | | |
| diethylphosphate | | | | | | | |
| (IL 169) | | | | | | | |
| Mixing ratio of | 100:4 | 100:4 | 100:4 | 100:33.3 | 100:4 | 100:4 | 100:4 |
| Part A:Part B | | | | | | | |

### Evaluations of the Examples

Each of the inventive examples and the comparative examples were tested for mixing viscosity, gel time, and pot life.

The mixing viscosity was measured at 25° C. and measured in cps (centipoise). The thermal rheology analysis to measure the mixing viscosity was performed in Discovery Hybrid Rheometers (DHR) from TA Instruments with a 25 mm aluminum disposable plate.

The gel time was measured at various temperatures ranging from 25° C. to 80° C. and measured in hours or minutes. The gel time measured at 25° C. was measured in a Gardner Standard Model Gel Timer, and the sample size for each example was about 100 grams. The gel time measured at 80° C. was measured in a Gelnorm Gel Timer, and the sample size for each example was about 12 grams.

The pot life was measured at 10° C., and the observed value was reported in days.

The results for each of the examples are summarized in Table 3 below.

TABLE 3

| | Inventive | Inventive | Inventive | Comparative | Comparative | Comparative | Comparative |
|---|---|---|---|---|---|---|---|
| | Example | Example | Example | Example | Example | Example | Example |
| | 1 | 2 | 3 | 1 | 2 | 3 | 4 |
| Mixing | 264 | 814 | 305 | 380 | 592 | 575 | 669 |
| viscosity at | | | | | | | |
| 25° C. (cps) | | | | | | | |
| Gel time at | 46 | 38 | 42 | 7 | | | |
| 23° C. (hrs), 100 | | | | | | | |
| gram | | | | | | | |
| Gel time at | 37.2 | 38.5 | 38.5 | 27.5 | 1033 | 250 | >1200 |
| 80° C. (min), | | | | | | | |
| Gelnorm | | | | | | | |
| 12 gram | | | | | | | |
| Pot life at 10° C. | 8 days | 8 days | 8 days | 1 days | | | |
| (days) | | | | | | | |

As illustrated in Table 3, Inventive Examples 1, 2, and 3 have low mixing viscosity at 25° C., fast reactivity at 80° C., long pot life at 10° C.

In particular, Inventive Example 1 exhibits a low mixing viscosity of 264 cps at 25° C., which is excellent for a wet-out of felt liner. Further, the gel time at 25° C. is 46 hours, and the pot life at 10° C. is 8 days. The long pot life provides sufficient working time from the impregnation of the felt liner to installation on the job site. In addition, the reactivity of Inventive Example 1 is rapid at 80° C. The gel time of Inventive Example 1 at 80° C. is only 37.2 minutes, which can be important for applications where fast curing of the impregnated liner is desired. Moreover, Inventive Example 1 shows a unique combination of low mixing viscosity (<5000 cps at 25° C.), long pot life (>2 days at 10° C.), and fast reactivity (<4 hours gel time at 80° C.).

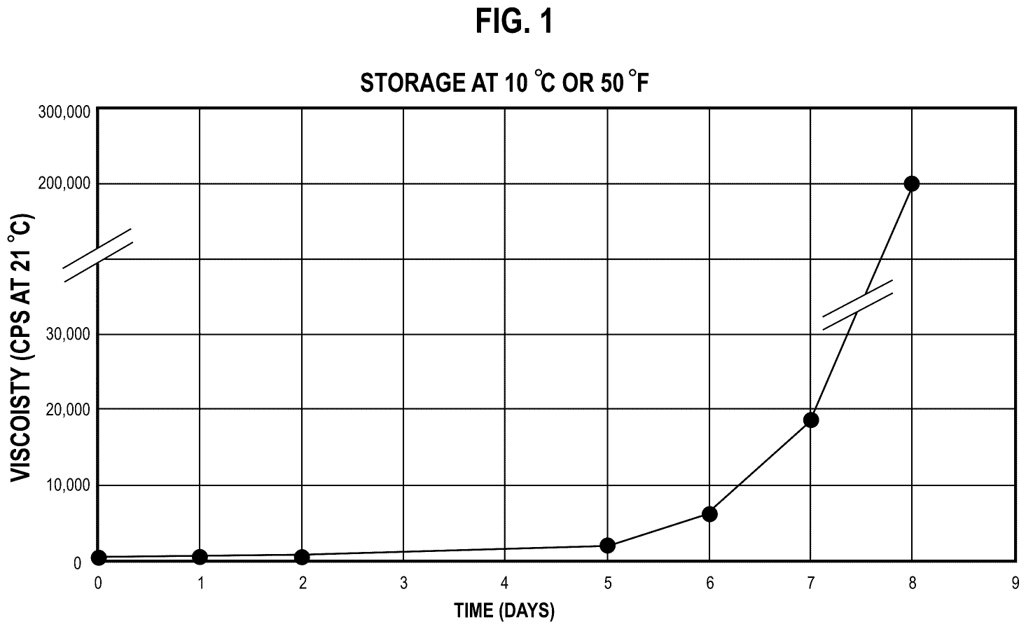

The pot life of Inventive Example 1 is measured by the increase of viscosity at 21° C. when the mixed system is stored at 10° C. or 50° F. When the viscosity of mixed system is above 300,000 cps at 21° C., it is considered to be not usable. As shown in FIG. 1, the mixed viscosity is slowly increased from 400 cps to 20,000 cps in the first 7 days if the mixed system is stored at 10° C. The viscosity is quickly increased from 20,000 cps to 200,000 cps from day 7 to day 8. After day 9, the viscosity is much above 300,000 cps, so we considered the pot life of Inventive Example 1 stored at 10° C. is 8 days.

Similarly, Inventive Example 2 has a low mixing viscosity of 814 cps at 25° C., a long pot life of 8 days at 10° C., and a fast reactivity of 38.5 minutes gel time at 80° C.

Similarly, Inventive Example 3 has a low mixing viscosity of 305 cps at 25° C., a long pot life of 8 days at 10° C., and a fast reactivity of 38.5 minutes gel time at 80° C.

Table 3 also illustrates the mixing viscosity, gel time, and pot life for Comparative Examples 1-4.

Comparative Example 1 represents a typical epoxy-amine system, including an epoxy resin provided in the form of D.E.R.383, and an epoxy hardener provided in the form of Jeffamine D230, where the mixing ratio of the epoxy resin to the accelerator is 100:33. Comparative Example 1 has a gel time at 25° C. of 11.5 hours, a gel time of 27.5 minutes at 80° C., and a pot life at 10° C. of 1 days. Thus, although the gel time of Comparative Example 1 is similar to the Inventive Examples at 80° C., the pot life of Comparative Example 1 is much shorter than the pot life of either Inventive Example 1-3. Accordingly, the shorter pot life of Comparative Example 1 makes it more difficult to transport and install a wet-out of felt liner using the curable epoxy composition disclosed in Comparative Example 1.

Comparative Examples 2-4 illustrate curable epoxy compositions with various accelerators such as TEA, AEP, and IL 169.

As shown, the gel time at 80° C. for the Comparative Examples including various accelerators such as TEA, AEP and IL169 is more than 250 minutes. Thus, Comparative Examples 2-4 have a relatively slow reactivity at a temperature of 80° C. as compared to the other examples.

Additionally, the mechanical properties and chemical resistance of Inventive Examples 1 were tested. The mechanical properties tested included tensile strength and flexural strength.

To test the mechanical properties, Inventive Example 1 was infused to 3 mm polyester felt with vacuum infusion method. The curing condition is 4 hours at 80° C.

The tensile tests were performed using the American Society for Testing and Materials (ASTM) D638 (type I) method by a screw-driven electromechanical machine (MTS Criterion-45). In one embodiment, the tensile strength was tested using a C-45 extensometer with a 50 mm (millimeter) axial gauge length.

The flexural tests were performed using ASTM D790. In one embodiment, the flexural strength of the Inventive Examples was tested using a C-45 load cell at 10 kN (kilonewton). In one embodiment, the flexural strength of the Inventive Examples was tested using a C-41 load cell at 1 kN.

The results are summarized in Table 4 below and compared with ASTM F1216-22 Standard Practice for Rehabilitation of Existing Pipelines and Conduits by the Inversion and Curing of a Resin-Impregnated Tube. The flexural properties and tensile properties of Inventive Example 1 meet the requirements listed in ASTM F1216 Table 1 CIPP Initial Structural Properties. For example, the minimal value of Flexural Strength listed in ASTM F1216 is 4,500 psi (310.26 bar), and tested minimal value of Flexural Strength of Inventive Example 1 is 7,090 psi (488.83 bar). The minimal value of Flexural Modulus listed in ASTM F1216 is 250,000 psi (17,236.89 bar), and the tested minimal value of Flexural Modulus of Inventive Example 1 is 352,900 psi (24331.59 bar).

TABLE 4
Tensile and Flexural Properties of Inventive Example 1

| | | ASTM | | |
|---|---|---|---|---|
| | | F1216 | Test value | Test value |
| | Test | minimum | minimum | average |
| Property | Method | value (psi) | (psi) | (psi) |
| Flexural Strength | D790 | 4500 | 7090 | 7350 |
| Flexural Modulus | D790 | 250 000 | 352 900 | 361 960 |
| Tensile Strength | D638 | 3000 | 4240 | 4440 |
| (for pressure pipe | | | | |
| only) | | | | |

The chemical resistance test of Inventive Example 1 was performed by following ASTM F1216-22 Appendixes X2 by exposing CIPP test specimens in tap water (pH 6-9), 5% nitric acid, 10% phosphoric acid, 10% sulfuric acid, gasoline, vegetable oil, 0.1% detergent and 0.1% soap for one month. The flexural properties of CIPP test specimens were tested before and after exposure. As illustrated in Table 5 below, the flexural strength retention of Inventive Example 1 is above 80%, which meets the requirements in ASTM F1216.

TABLE 5
Chemical Resistance Test of Inventive Example 1

| | Flexural | Flexural | |
|---|---|---|---|
| | Strength | Strength | Requirements in |
| | (psi) | Retention (%) | ASTM F1216 |
| Control Specimen | 7350 | | |
| Tap Water | 6950 | 95% | >80% |
| (pH 6-9) | | | |
| 5% Nitric Acid | 7560 | 103% | >80% |
| 10% Phosphoric | 6890 | 94% | >80% |
| Acid | | | |
| 10% Sulfuric Acid | 7480 | 102% | >80% |
| Gasoline | 5980 | 81% | >80% |
| Vegetable Oil | 7620 | 104% | >80% |
| 0.1% Detergent | 7090 | 96% | >80% |
| 0.1% Soap | 7360 | 100% | >80% |

When introducing elements of the present disclosure or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A cured-in-place pipe lining system, comprising:
an epoxy resin component comprising at least one epoxy resin;
an accelerator component comprising an imidazole of Formula I, 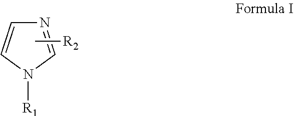
wherein R¹ and R² are each independently selected from the group consisting of hydrogen, C₁-C₂₀ alkyl, C₁-C₂₀ alkoxyl, C₁-C₂₀ hydroxyalkyl, C₁-C₂₀ cyanoalkyl, C₁-C₂₀ aminoalkyl, and monocyclic aryl; and
a flexible pipe lining material.

2. The cured-in-place pipe lining system of claim 1 wherein R¹ and R² are each independently selected from the group consisting of hydrogen, methyl, ethyl, propyl, isopropyl, butyl, isobutyl, pentyl, hexyl, hydroxymethyl, hydroxyethyl, hydroxypropyl, cyanomethyl, cyanoethyl, cyanopropyl, aminomethyl, aminoethyl, aminopropyl, phenyl, and benzyl.

3. The cured-in-place pipe lining system of claim 1 wherein the accelerator component comprises at least one imidazole selected from the group consisting of 1,2-dimethyl imidazole, 1-benzyl-2-methylimidazole, 1-cyanoethyl-2-ethyl-4-methylimidazole, 1-cyanoethyl-2-methylimidazole, 1-aminoethyl-2-methylimidazole, 2-methylimidazole, 4-methylimidazole, 2,4-dimethylimidazole, 2-ethyl-4-methyl imidazole, 2-ethyliidazole, 2-undecylimidazole, 2-heptadecylimidazole, 2-phenylimidazole, 2-phenyl-4-methylimdazole, 1-(2-hydroxypropyl) imidazole and combinations thereof.

4. The cured-in-place pipe lining system of claim 3 wherein the accelerator component comprises at least one imidazole selected from the group consisting of 1,2-dimethyl imidazole, 2,4-dimethylimidazole, 2-ethyl-4-methyl imidazole, 1-benzyl-2-methylimidazole, and 1-cyanoethyl-2-ethyl-4-methylimidazole, 1-(2-hydroxypropyl) imidazole.

5. The cured-in-place pipe lining system of claim 1 wherein the accelerator component further comprises a diluent selected from the group consisting of a polyol, a polyether amine, a cycloaliphatic amine, an aliphatic amine, and combinations thereof.

6. The cured-in-place pipe lining system of claim 1 wherein the curable epoxy composition exhibits at least one of:
(a) a mixing viscosity of less than about 5000 centipoise at a temperature of about 25° C.;
(b) a pot life of greater than about two days at a temperature of about 10° C.; and
(c) a gel time of less than about four hours at a temperature of about 80° C.

7. The cured-in-place pipe lining system of claim 1 wherein the epoxy resin component comprises a diglycidyl ether.

8. The cured-in-place pipe lining system of claim 1 wherein the curable epoxy composition comprises the epoxy resin component and the accelerator component in a weight ratio of from about 10:1 to about 100:1.

9. The cured-in-place pipe lining system of claim 1 wherein the flexible pipe lining material comprises a synthetic textile felt selected from the group consisting of polyester such as poly(ethylene terephthalate), polyacrylonitrile, polyethylene, poly(ethylene naphthate), poly(p-phenylene terephthalamide), fiberglass, carbon fiber, and combinations thereof.

10. A curable pipe liner comprising a flexible pipe lining material impregnated with a curable epoxy composition,
wherein the curable epoxy composition comprises:
an epoxy resin component comprising at least one epoxy resin; and
an accelerator component comprising an imidazole of Formula I, 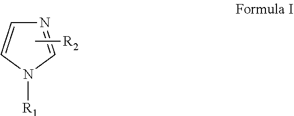
wherein R¹ and R² are each independently selected from the group consisting of hydrogen, C₁-C₂₀ alkyl, C₁-C₂₀ alkoxyl, C₁-C₂₀ hydroxyalkyl, C₁-C₂₀ cyanoalkyl, C₁-C₂₀ aminoalkyl, and monocyclic aryl; and
wherein the flexible pipe lining material comprises a natural or synthetic textile felt.

11. The cured-in-place pipe lining system of claim 10 wherein R¹ and R² are each independently selected from the group consisting of hydrogen, methyl, ethyl, propyl, isopropyl, butyl, isobutyl, pentyl, hexyl, hydroxymethyl, hydroxyethyl, hydroxypropyl, cyanomethyl, cyanoethyl, cyanopropyl, aminomethyl, aminoethyl, aminopropyl, phenyl, and benzyl.

12. The cured-in-place pipe lining system of claim 10 wherein the accelerator component comprises at least one imidazole selected from the group consisting of 1,2-dimethyl imidazole, 1-benzyl-2-methylimidazole, 1-cyanoethyl-2-ethyl-4-methylimidazole, 1-cyanoethyl-2-methylimidazole, 1-aminoethyl-2-methylimidazole, 2-methylimidazole, 4-methylimidazole, 2,4-dimethylimidazole, 2-ethyl-4-methyl imidazole, 2-ethyliidazole, 2-undecylimidazole, 2-heptadecylimidazole, 2-phenylimidazole, 2-phenyl-4-methylimdazole, 1-(2-hydroxypropyl) imidazole and combinations thereof.

13. The cured-in-place pipe lining system of claim 12 wherein the accelerator component comprises at least one imidazole selected from the group consisting of 1,2-dimethyl imidazole, 2,4-dimethylimidazole, 2-ethyl-4-methyl imidazole, 1-benzyl-2-methylimidazole, and 1-cyanoethyl-2-ethyl-4-methylimidazole, 1-(2-hydroxypropyl) imidazole.

14. The cured-in-place pipe lining system of claim 10 wherein the accelerator component further comprises a diluent selected from the group consisting of a polyol, a polyether amine, a cycloaliphatic amine, an aliphatic amine, and combinations thereof.

15. The cured-in-place pipe lining system of claim 10 wherein the curable epoxy composition exhibits at least one of:
(a) a mixing viscosity of less than about 5000 centipoise at a temperature of about 25° C.;
(b) a pot life of greater than about two days at a temperature of about 10° C.; and
(c) a gel time of less than about four hours at a temperature of about 80° C.

16. The cured-in-place pipe lining system of claim 10 wherein the epoxy resin component comprises a diglycidyl ether.

17. The cured-in-place pipe lining system of claim 10 wherein the curable epoxy composition comprises the epoxy resin component and the accelerator component in a weight ratio of from about 10:1 to about 100:1.

18. A method for rehabilitating a pipe, comprising:
inserting the curable pipe liner of claim 10 into an existing pipe in need of rehabilitation;
inflating the curable pipe liner until an outer surface of the liner is pressed against an inner wall of the pipe; and
curing the liner until the liner hardens.

19. The method of claim 18 wherein the liner is cured by supplying steam or hot water to the interior of the pipe.

20. A cured-in-place pipe lining system prepared using the method of claim 18.
